(19) United States
(12) Patent Application Publication
(10) Pub. No.: US 2023/0221200 A1
(43) Pub. Date: Jul. 13, 2023

(54) SYSTEM AND METHOD FOR DETERMINING LOAD ON WINCH HOOK

(71) Applicant: Delaware Capital Formation, Inc, Wilmington, DE (US)

(72) Inventor: KENNETH W. BLAKE, Bristow, OK (US)

(21) Appl. No.: 18/095,485

(22) Filed: Jan. 10, 2023

Related U.S. Application Data
(60) Provisional application No. 63/297,921, filed on Jan. 10, 2022.

(51) Int. Cl. G01L 5/102; G01L 1/22

(52) U.S. Cl. CPC G01L 5/102; G01L 1/2262; G01L 1/2218

(57) ABSTRACT

A system for measuring a load lifted by a lifting machine includes a winch with a rope wound onto a drum, the drum being rotatable to wind and unwind the rope affixed to the load to lift and lower the load, end supports affixing the drum to the lifting machine, and at least one strain gauge affixed to the end supports and measuring a strain applied to the end supports by the load on the rope.

### CROSS-REFERENCE TO RELATED CASES

This application claims the benefit of U.S. provisional patent application Ser. No. 63/297,921, filed on Jan. 10, 2022, and incorporates such provisional application by reference into this disclosure as if fully set out at this point.

### FIELD OF THE INVENTION

This disclosure relates to lifting machines in general and, more specifically, to a system and method for determining a line load on a winch or hoist.

### BACKGROUND OF THE INVENTION

Knowing the weight or mass of a load being carried, moved, or held by a winch or lifting machine can be crucial to its operation. In some cases, the weight of a load may not be known before there is need to move it. Knowing the weight of the load enables the operator to consult lift or load charts as conditions require.

What is needed is a system and method for addressing the above and related issues.

### SUMMARY OF THE INVENTION

The invention of the present disclosure, in one aspect thereof, comprises a system for measuring a load lifted by a lifting machine. The system includes a winch with a rope wound onto a drum, the drum being rotatable to wind and unwind the rope affixed to the load to lift and lower the load, end supports affixing the drum to the lifting machine, and at least one strain gauge affixed to the end supports and measuring a strain applied to the end supports by the load on the rope.

In some embodiment, the system further comprises a computing circuit receiving an electric signal from the at least one strain gauge that is representative of the strain on the end supports and converting the signal to an output indicating the weight of the load. The at least one strain gauge may comprise a plurality of strain gauges, each providing an electric signal to the strain gauge that is representative of the strain on the end supports. The computing circuit may convert the electric signal from each of the plurality of strain gauges to the output indicating the weight of the load.

In some cases, the plurality of strain gauges is affixed to the end supports such that strain is measured along a plurality of directions. The plurality of strain gauges may be placed in a bridge configuration. The plurality of strain gauges may comprise a plurality of micro-electro-mechanical strain gauges.

The system may further include a display indicating the weight of the load. It may comprise of a boom extending away from the winch, wherein the rope extends from the drum along the boom and the load is lifted below the extended boom by the rope. In some cases, the end supports comprise a pair of end supports.

The invention of the present disclosure, in another aspect thereof, comprise a system for measuring a load lifted by a winch affixed to a load lifting machine. The system includes a winch drum that is rotated to wind and unwind a winch line to lift and lower a load on the winch line, a pair of end supports holding the winch drum and affixing the winch drum to the load lifting machine, a strain gauge affixed to a first one of the pair of end supports measuring a strain applied to the first one of the pair of end supports by the load on the winch line, and a computing circuit that converts the measured strain to an output signal indicative of a weight of the load on the winch line.

The strain gauge may be a micro-electro-mechanical strain gauge. In some cases, the system further comprises at least one additional strain gauge affixed to the first one of the pair of end supports and measuring the strain applied to the first one of the pair of end supports by the load on the winch line, the measured strain from the at least one additional strain gauge being converted by the computing circuit, along with the measured strain from the strain gauge, to generate the output signal indicative of the weight of the load on the winch line.

The strain gauge and the at least one additional strain gauge may be affixed to the first one of the pair of end supports at an angle with respect to one another. The strain gauge and the at least one additional strain gauge may be arranged in a bridge configuration.

The invention of the present disclosure, in another aspect thereof, comprises a method of determining a weight of a load lifted by a lifting machine utilizing a winch having a rotatable drum winding and unwinding a winch line to lift the load, the winch being mounted to the lifting machine by at least one end support. The method includes applying a strain gauge to the at least one end support, detecting with the strain gauge a strain on the at least one end support when the load is lifted by the winch, receiving the detected strain gauge with a computing circuit, and converting the detected strain to a weight with the computing circuit.

In some embodiments, applying a strain gauge comprises applying a plurality of strain gauges at varying angles with respect to one another, detecting the strain comprises detecting the strain with each of the plurality of strain gauges, receiving the detected stain comprises receiving the detected strain from each of the plurality of strain gauges, and converting the detected strain comprises converting the detected strain from each of the plurality of strain gauges to the weight with the computing circuit. Applying a strain gauge may comprises applying the plurality of strain gauges in a bridge configuration.

The method may further comprise displaying the weight on a display. The method may comprise logging the weight in a storage medium.

### BRIEF DESCRIPTION OF THE DRAWINGS

FIG. 1 is a side view of a lifting machine according to aspects of the present

disclosure.

FIG. 2 is a block diagram of a system for determining a load lifted by a winch according to aspects of the present disclosure.

FIG. 3 is a perspective view of a winch according to aspects of the present

disclosure.

FIG. 4 is a closeup view of a strain gauge placed on a winch for finite element analysis according to aspects of the present disclosure.

FIG. 5 is a closeup of strain gauges placed on a winch according to aspects of the present disclosure.

FIG. 6 is another closeup of strain gauge placement according to aspects of the present disclosure.

FIG. 7 is another closeup of strain gauge placement according to aspects of the present disclosure.

FIG. 8A illustrates a schematic diagram of strain gauges placed in a bridge

configuration.

FIG. 8B illustrates a strain gauge placement in three dimensions.

FIG. 9 is a chart of a finite element analysis according to the present disclosure.

FIG. 10 is another chart of a finite element analysis according to the present disclosure.

### DETAILED DESCRIPTION OF THE PREFERRED EMBODIMENTS

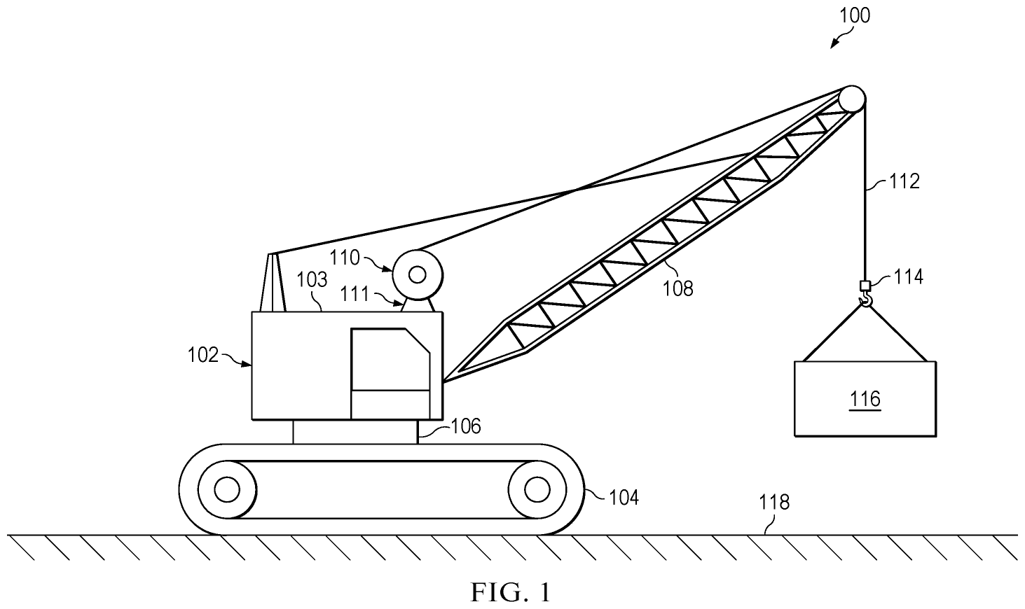

FIG. 1 is a side view of a lifting machine 100. Lifting machine 100 is a boom crane and represents one kind of lifting machine with which embodiments of the present disclosure may operate. Other types of cranes, lifting devices, or lifting machines may also be used with systems and methods of the present disclosure. These would include, but are not limited to, lattice work cranes, tower cranes, loader cranes, truck mounted cranes and others. Embodiments of the present disclosure may be retrofitted to operate on existing cranes or may be integrated with a crane at the time of manufacture.

The crane 100 comprises an upper portion 102, which may provide a cab 103 and other working components, affixed in a rotational articulating fashion to a base 104. The base 104 may provide locomotion and gross positioning for lifting, moving, and other work performed by the crane 100. The upper portion 102 may be fixed to the base 104 by a rotational drive mechanism 106. The rotational drive mechanism 106 may also be known as a rotex gear. The rotational drive mechanism 106 may comprise a slew ring and associated powered drive gears and controllers.

The upper portion 102 provides a boom 108 from which loads may be lifted and moved. A single-piece boom 108 is shown but it should be understood that multi-piece booms with jibs and other subcomponents may be utilized.

A winch 110 may be mounted to the upper portion 102 the lifting machine 100 or in another stable location. The winch may be affixed to the lifting machine 100 via end supports 110. The winch 110 or spools and unspools winch line 112 for lifting and lowering loads using a load hook 114. The winch line 112 may also be known in the art as a “rope”. However, the term “rope” should be understood to encompass any line or cable used with a winch for lifting or movement of loads. The winch line 112 may comprise a woven steel cable or other winch line as is known in the art. The load hook 114 may or may not comprise an actual hook. The load hook 112 serves as a location for securement and release of an associated load 116. Here, the load 116 is shown as a simple box or crate but other loads of varying types are contemplated herein.

In addition to lifting and lowering, the crane 100 may also rotate the boom 108 as a component of the upper portion in relation to the base 104. Thus, loads may be lifted and moved based on manipulation or rotation of the rotational drive mechanism 106 and the hoist 110. The base 104 may remain stationary with respect to a work surface 118 when loads are being manipulated. The work surface 118 may be a piece of ground or concrete at a work site, for example. The crane 100 may include various outriggers, counterweights, and additional components as are known in the art.

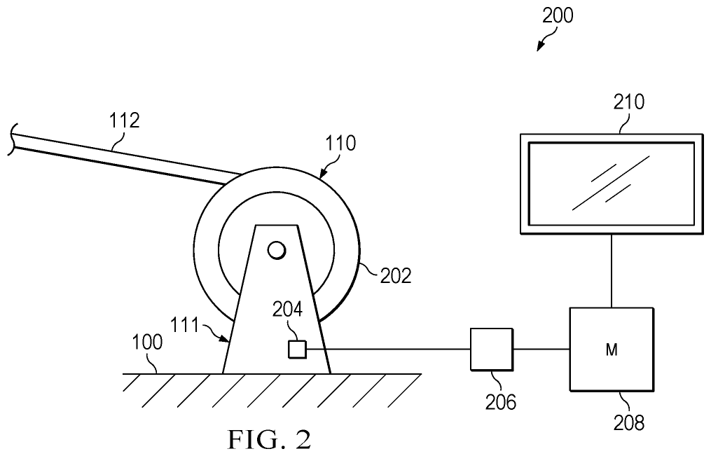

Referring now to FIG. 2 a block diagram of a system 200 for determining a load lifted by a winch on a lifting machine according to aspects of the present disclosure is shown. FIG. 200 is not shown to scale. For simplicity, supporting components such as power supplies, ground leads, etc. as are known in the art are not shown. Additionally, the lifting machine 100 is represented only as a mounting location for the winch 110. The winch 110 may be mounted in a number of locations on a lifting machine as discussed above.

The winch 110 may comprise a drum 202 that is powered (e.g., via an electric motor) to wind and unwind to spool in and out the winch line 112 for lifting or movement of loads. The winch 110 may be rotationally mounted to the lifting machine 100 via one or more end supports 111. A pair of end supports 111 may be used to retain the winch 110—with one on either end of the drum 202, for example.

According to various embodiments of the present disclosure, the system 200 comprises a strain gauge 204 applied to a predetermined location on or more of the end supports 204, on the drum 202, or another location that experiences physical strain when a load if lifted by the line 112. Note that the lift may occur by movement of the drum 202, but could also occur by movement of some other part of the lifting machine 100 that causes the line 112 to lift or move the load (e.g., elevation of the boom 108 may result in a load lift and/or measurable strain applied to various components). Strain read from a location on the winch 110 drum can be correlated to tension, pulling force, or line pull on as associated winch rope, line, or cable 112.

The strain gauge 204 may be a micro-electro-mechanical (MEMS) device. The strain gauge 204 may be placed in a location that undergoes a predictable strain that may be correlated directly to the weight of the load on the line 112. A strain gauge 204 may be placed in more than one location. As discussed further below, more than one strain gauge may be used in various physical arrangements at a single location to account for distortions and mechanical effects that are not due directly to the weight of the load on the line 112. Systems of the present disclosure work irrespective of rope size and may be used with or without a rope angle sensor as known in the art.

Signals (usually a voltage or change in resistance) obtained from the strain gauge 204 (or gauges) may tend to me low in amplitude and subject to degradation by circuit noise or interference. A signal conditioning circuit 206, as is known in the art, may be placed sufficiently near the strain gauge or gauges 204 to clean, filter, amplify, and/or otherwise modify the signal(s) for further processing. In some cases, signal conditioning circuity is placed directly on the end supports 111, drum 202, or wherever the associated strain gauge is mounted. In some embodiments, the signal conditioning circuit 206 is packaged into a single physical box that may be resilient against weather, temperature, vibration, and other conditions expected to be encountered.

A computing circuit 208 may receive the signal(s) from the conditioning circuit 206 or strain gauge(s) 204 and convert the received values to a weight. The computing circuit 208 may comprise a programmable microprocessor or other solid-state computing device as is known in the art. The computing circuit 208 may also comprise a memory or non-volatile storage for logging recorded values. The computing circuit 208 may also communicate with various control computers as are known in the art, or may comprise a control computer. A display 210 may provide a readout indicating the weight of the load as calculated based on the strain gauge readings. The display 210 may have an associated alarm. Visual and/or audible alarms may be provided if an allowable line load is exceeded and/or if the measure load passes a predetermined threshold.

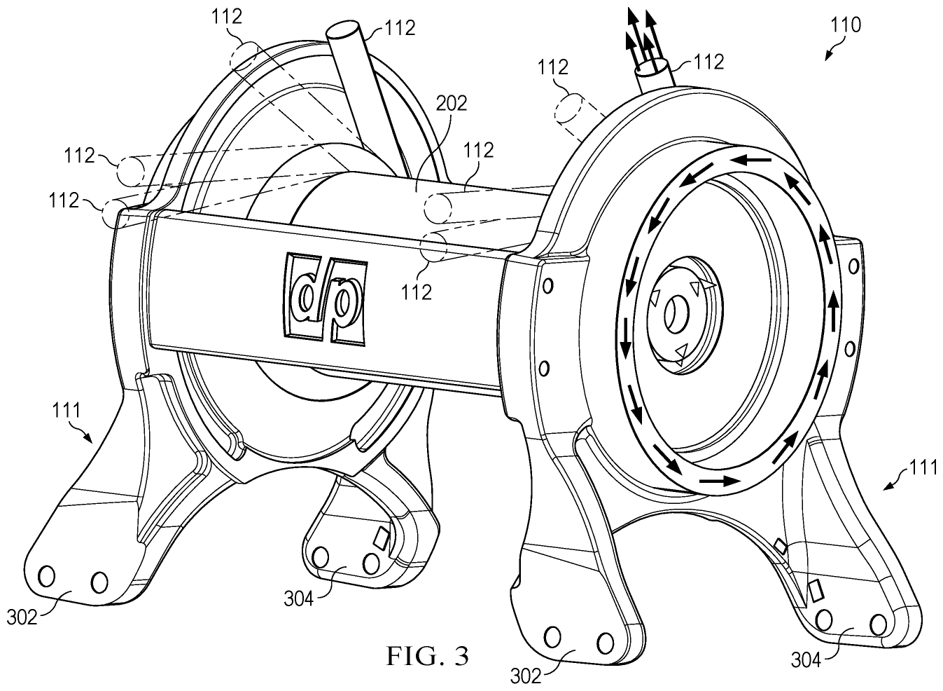

Referring now to FIG. 3, a simplified perspective view of a winch 110 according to aspects of the present disclosure is shown. The drum 202 can be seen with the rope 112 shown leaving the drum 202 at various angles and at either end of the drum 202. It should be understood that the rope 112 will only depart from the drum 202 at a single angle and location that varies between either end of the drum 202, but that multiple angles and location are shown for illustration. Due to weight or line pull on the rope 112 a torque will be detected on the drum 202 (shown as arrows on the end of drum 202) and a strain can be detected at various locations such as the base or end support 111. End supports 111 are susceptible to various physical implementations but, as shown, some have separate front legs 302 and rear legs 304.

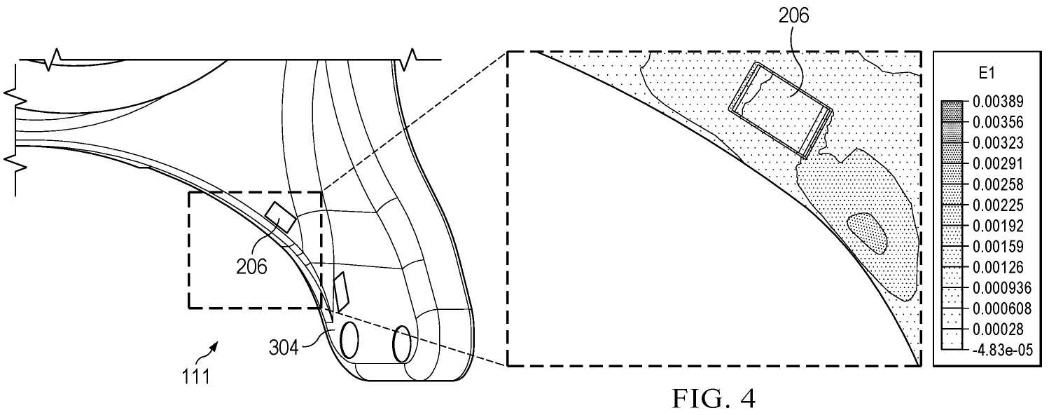

Referring now to FIG. 4, a closeup view of a strain gauge 206 placed on a winch end support 111 for finite element analysis according to aspects of the present disclosure is shown. FIG. 4 shows one possible useful placement for a strain gauge 206 on the drum mounting structure or end support 111. It will be appreciated that the strain gauge 206 may be placed on the winch structure rather than on a mounting structure or other less convenient location. Finite element analysis (FEA) studies may be conducted to arrive at a useful approximation of the correlation between measured strain and line pull. In practice, a calibration procedure may be utilized to ensure that observed or read strain correlates in actuality with line pull.

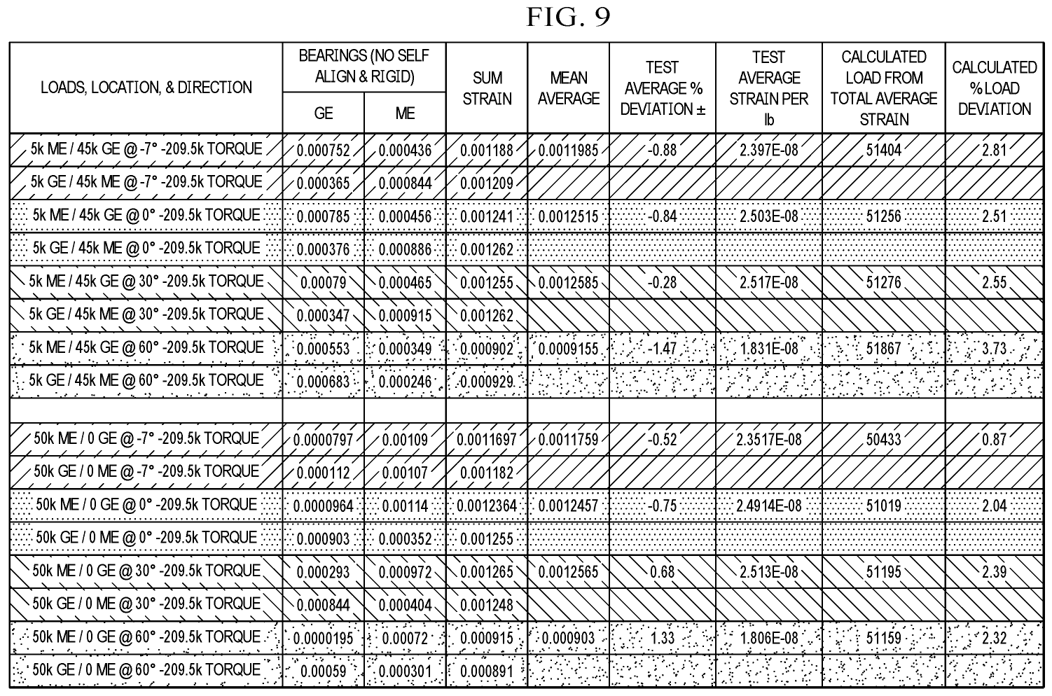

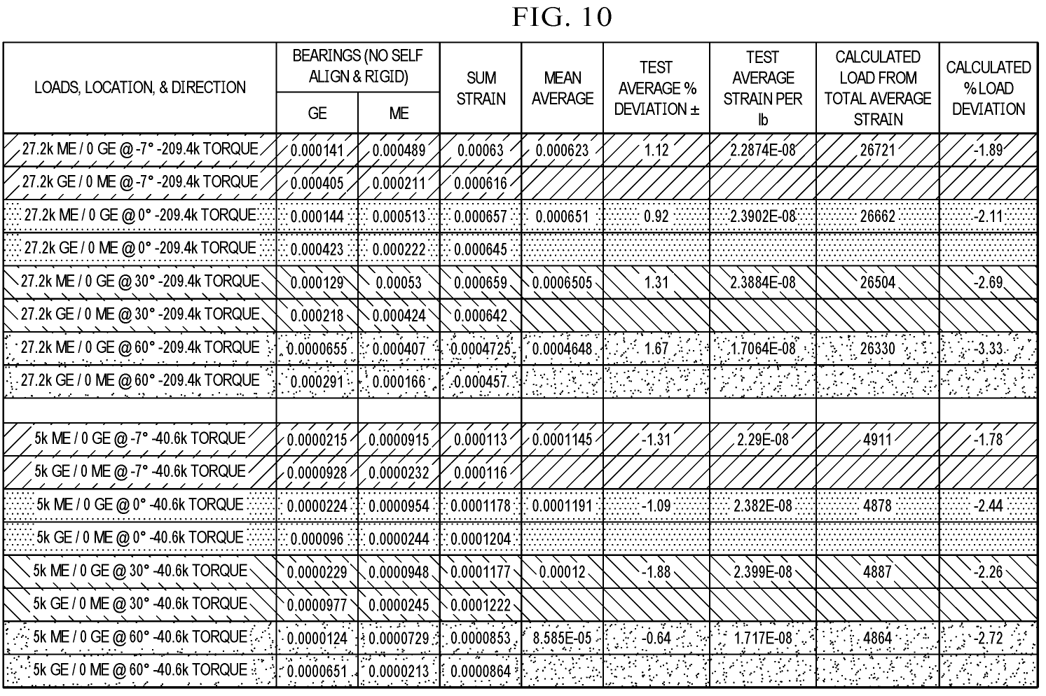

In one example, a system according to the present disclosure was modeled as shown in FIGS. 3-4. The model has a simplified drum 202 to transfer appropriate loads to the bearings (not shown) and through to the end supports 111. FEA studies were created with various loads and angles to determine points of consistent strain. The simulation results are appended hereto as FIGS. 9 and 10. The following definitions are used:

GE/ME: recorded 1st principal strain;

Sum Strain:=GE+ME strain;

Mean Average: Average of the two tests;

Test Average % Deviation: Percent of deviation of the individual tests from Mean Average;

Test Average Strain per lb:=Mean Average/total load;

Total Average Strain per lb (all tests):=the average strain per lb from all four tests;

Calculated Load from Total Average Strain:=Mean Average/Total Average Strain; and

Calculated % Load Deviation:=Percent of deviation based on the Total Average Strain.

Note that “GE” refers to a so-called gear end of the winch, while “ME” refers to the motor end.

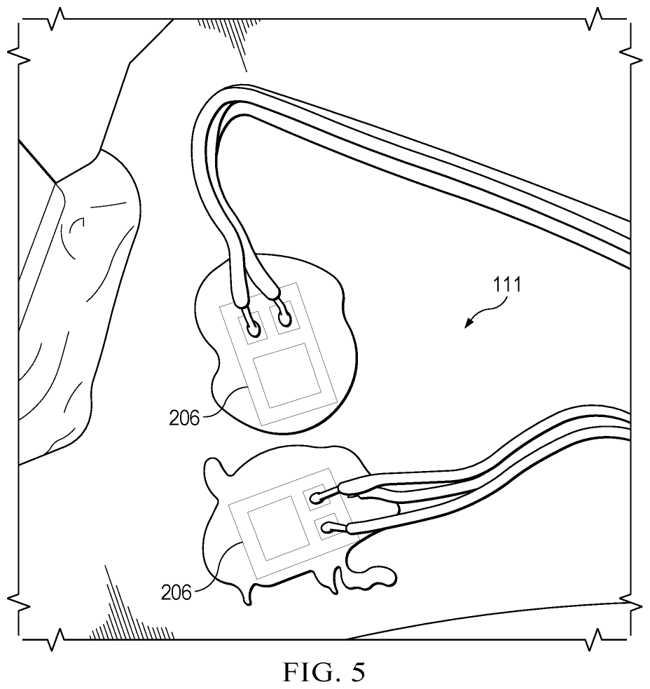

Referring now to FIG. 5, a closeup of strain gauges placed on a winch according to aspects of the present disclosure is shown. In some embodiments, multiple strain gauges 206 may be used at approximately the same location on the winch to reduce error distortions cause by the load that do not necessarily correlate to load on the line 112. FIG. 5 illustrates such an arrangement in a testing procedure. The strain gauges 206 may be placed in a tee configuration, offset about 90 degrees from one another.

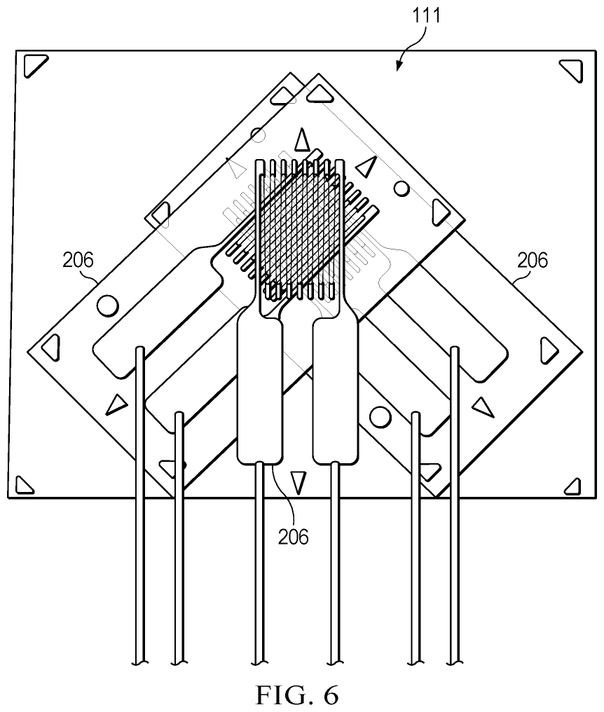

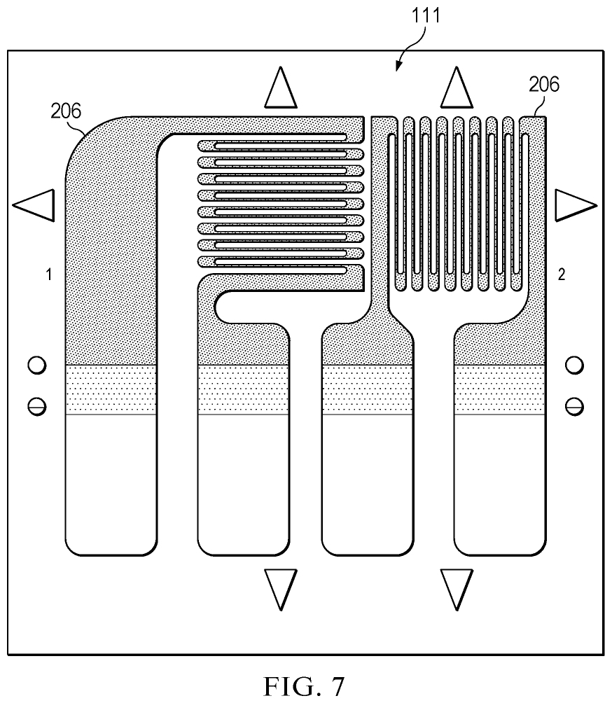

Referring now to FIG. 6 another closeup of strain gauge placement according to aspects of the present disclosure is shown. As shown in FIG. 6, some embodiments, may utilize 3 or more strain gauges 206 eliminate error. Here they are shown stacked or superimposed. Referring now to FIG. 7, it can be seen multiple gauges 206 may be placed adjacent to one another.

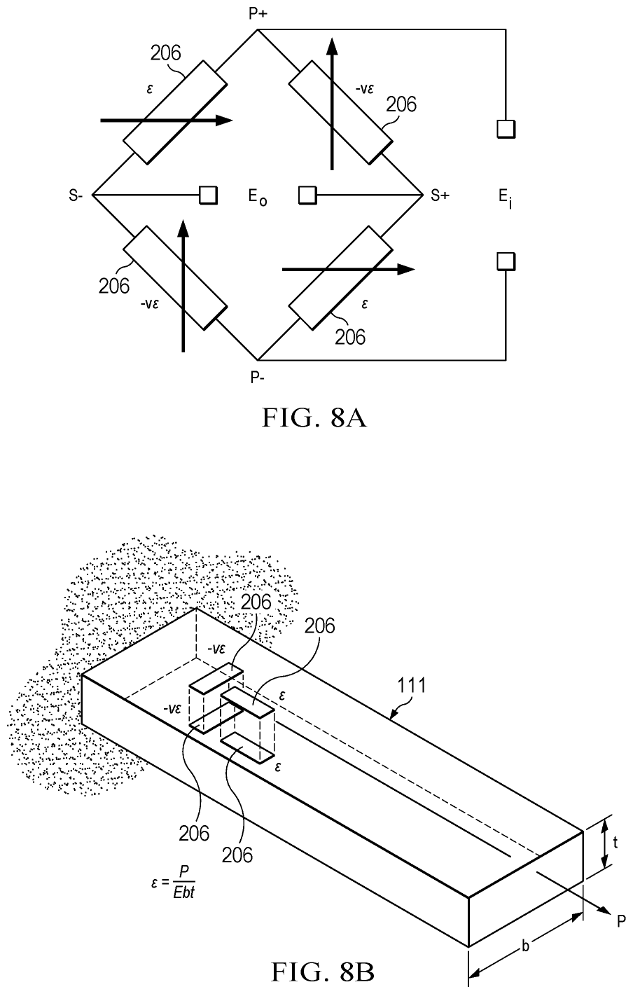

Referring now to FIG. 8 a schematic diagram of strain gauges 206 placed in a bridge configuration is shown. As known in the art, placement of measuring devices such as strain gauges 206 in a bridge configuration (schematically) can yield increased sensitivity and/or reduced errors. Strain gauges arranged electrically into a bridge configuration may be placed physically in a bridge configuration or in another useful physical arrangement. FIG. 8B illustrates a strain gauge 206 placement in three dimensions relative to a portion of an end support 111. It is understood that another location on the winch 110 or support structure could be utilized with multiple strain gauges 206 placed on opposite sides of a support location. These may then be connected electrically in a bridge configuration as in FIG. 8A, or in another configuration.

In an example, a winch was constructed according to FIGS. 3-4, but with a pair of strain gauges placed relative to one another as shown in FIG. 5 (tee configuration or 90-degree offset). The device was tested and found to accurately indicate winch line load.

It is to be understood that the terms “including”, “comprising”, “consisting” and grammatical variants thereof do not preclude the addition of one or more components, features, steps, or integers or groups thereof and that the terms are to be construed as specifying components, features, steps or integers.

If the specification or claims refer to “an additional” element, that does not preclude there being more than one of the additional element.

It is to be understood that where the claims or specification refer to “a” or “an” element, such reference is not be construed that there is only one of that element.

It is to be understood that where the specification states that a component, feature, structure, or characteristic “may”, “might”, “can” or “could” be included, that particular component, feature, structure, or characteristic is not required to be included.

Where applicable, although state diagrams, flow diagrams or both may be used to describe embodiments, the invention is not limited to those diagrams or to the corresponding descriptions. For example, flow need not move through each illustrated box or state, or in exactly the same order as illustrated and described.

Methods of the present invention may be implemented by performing or completing manually, automatically, or a combination thereof, selected steps or tasks.

The term “method” may refer to manners, means, techniques and procedures for accomplishing a given task including, but not limited to, those manners, means, techniques and procedures either known to, or readily developed from known manners, means, techniques and procedures by practitioners of the art to which the invention belongs.

The term “at least” followed by a number is used herein to denote the start of a range beginning with that number (which may be a range having an upper limit or no upper limit, depending on the variable being defined). For example, “at least 1” means 1 or more than 1. The term “at most” followed by a number is used herein to denote the end of a range ending with that number (which may be a range having 1 or 0 as its lower limit, or a range having no lower limit, depending upon the variable being defined). For example, “at most 4” means 4 or less than 4, and “at most 40%” means 40% or less than 40%.

When, in this document, a range is given as “(a first number) to (a second number)” or “(a first number)-(a second number)”, this means a range whose lower limit is the first number and whose upper limit is the second number. For example, 25 to 100 should be interpreted to mean a range whose lower limit is 25 and whose upper limit is 100. Additionally, it should be noted that where a range is given, every possible subrange or interval within that range is also specifically intended unless the context indicates to the contrary. For example, if the specification indicates a range of 25 to 100 such range is also intended to include subranges such as 26-100, 27-100, etc., 25-99, 25-98, etc., as well as any other possible combination of lower and upper values within the stated range, e.g., 33-47, 60-97, 41-45, 28-96, etc. Note that integer range values have been used in this paragraph for purposes of illustration only and decimal and fractional values (e.g., 46.7-91.3)should also be understood to be intended as possible subrange endpoints unless specifically excluded.

It should be noted that where reference is made herein to a method comprising two or more defined steps, the defined steps can be carried out in any order or simultaneously (except where context excludes that possibility), and the method can also include one or more other steps which are carried out before any of the defined steps, between two of the defined steps, or after all of the defined steps (except where context excludes that possibility).

Further, it should be noted that terms of approximation (e.g., “about”, “substantially”, “approximately”, etc.) are to be interpreted according to their ordinary and customary meanings as used in the associated art unless indicated otherwise herein. Absent a specific definition within this disclosure, and absent ordinary and customary usage in the associated art, such terms should be interpreted to be plus or minus 10% of the base value.

Thus, the present invention is well adapted to carry out the objects and attain the ends and advantages mentioned above as well as those inherent therein. While the inventive device has been described and illustrated herein by reference to certain preferred embodiments in relation to the drawings attached thereto, various changes and further modifications, apart from those shown or suggested herein, may be made therein by those of ordinary skill in the art, without departing from the spirit of the inventive concept the scope of which is to be determined by the following claims.

What is claimed is:

1. A system for measuring a load lifted by a lifting machine comprising:
a winch with a rope wound onto a drum, the drum being rotatable to wind and unwind the rope affixed to the load to lift and lower the load;
end supports affixing the drum to the lifting machine; and
at least one strain gauge affixed to the end supports and measuring a strain applied to the end supports by the load on the rope.

2. The system of claim 1, further comprising a computing circuit receiving an electric signal from the at least one strain gauge that is representative of the strain on the end supports and converting the signal to an output indicating the weight of the load.

3. The system of claim 2, wherein the at least one straight gauge comprises a plurality of strain gauges, each providing an electric signal to the computing circuit that is representative of the strain on the end supports.

4. The system of claim 3, wherein the computing circuit converts the electric signal from each of the plurality of strain gauges to the output indicating the weight of the load.

5. The system of claim 3, wherein the plurality of strain gauges is affixed to the end supports such that strain is measured along a plurality of directions.

6. The system of claim 3, wherein the plurality of strain gauges is placed in a bridge configuration.

7. The system of claim 6, wherein the plurality of strain gauges comprises a plurality of micro-electro-mechanical strain gauges.

8. The system of claim 2, further comprising a display indicating the weight of the load.

9. The system of claim 1, further comprising a boom extending away from the winch, wherein the rope extends from the drum along the boom and the load is lifted below the extended boom by the rope.

10. The system of claim 1, wherein the end supports comprise a pair of end supports.

11. A system for measuring a load lifted by a winch affixed to a load lifting machine comprising:
a winch drum that is rotated to wind and unwind a winch line to lift and lower a load on the winch line;
a pair of end supports holding the winch drum and affixing the winch drum to the load lifting machine;
a strain gauge affixed to a first one of the pair of end supports measuring a strain applied to the first one of the pair of end supports by the load on the winch line; and
a computing circuit that converts the measured strain to an output signal indicative of a weight of the load on the winch line.

12. The system of claim 11, wherein the strain gauge is a micro-electro-mechanical strain gauge.

13. The system of claim 12, further comprising at least one additional strain gauge affixed to the first one of the pair of end supports and measuring the strain applied to the first one of the pair of end supports by the load on the winch line, the measured strain from the at least one additional strain gauge being converted by the signal conditioning circuit, along with the measured strain from the strain gauge, to generate the output signal indicative of the weight of the load on the winch line.

14. The system of claim 13, wherein the strain gauge and the at least one additional strain gauge are affixed to the first one of the pair of end supports at an angle with respect to one another.

15. The system of claim 14, wherein the strain gauge and the at least one additional strain gauge are arranged in a bridge configuration.

16. A method of determining a weight of a load lifted by a lifting machine utilizing a winch having a rotatable drum winding and unwinding a winch line to lift the load, the winch being mounted to the lifting machine by at least one end support, the method comprising:
applying a strain gauge to the at least one end support;
detecting with the strain gauge a strain on the at least one end support when the load is lifted by the winch;
receiving the detected strain gauge with a computing circuit; and
converting the detected strain to a weight with the computing circuit.

17. The method of claim 16, wherein:
applying a strain gauge comprises applying a plurality of strain gauges at varying angles with respect to one another;
detecting the strain comprises detecting the strain with each of the plurality of strain gauges;
receiving the detected stain comprises receiving the detected strain from each of the plurality of strain gauges; and
converting the detected strain comprises converting the detected strain from each of the plurality of strain gauges to the weight with the computing circuit.

18. The method of claim 17, wherein applying a strain gauge comprises applying the plurality of strain gauges in a bridge configuration.

19. The method of claim 18, further comprising displaying the weight on a display.

20. The method of claim 19, further comprising logging the weight in a storage medium.
